(19) United States
(12) Patent Application Publication
(10) Pub. No.: US 2015/0290071 A1
(43) Pub. Date: Oct. 15, 2015

(54) Multiple Degree of Freedom Portable Rehabilitation System Having DC Motor-Based, Multi-Mode Actuator

(71) Applicant: NORTHEASTERN UNIVERSITY, Boston, MA (US)

(72) Inventors: Patrick Joseph Murphy, Stoneham, MA (US); Ray Adler, Olympia, WA (US); Katherine Bausemer, Braintree, MA (US); Joseph Gonsalves, Greenville, RI (US); Kevin Thompson, Framingham, MA (US); Qingchao Kong, Revere, MA (US); Mark L. Sivak, Boston, MA (US); Constantinos Mavroidis, Arlington, MA (US)

(21) Appl. No.: 14/647,554

(22) PCT Filed: Dec. 2, 2013
(86) PCT No.: PCT/US13/72628

§ 371 Date: May 27, 2015

Related U.S. Application Data
(60) Provisional application No. 61/732,008, filed on Nov. 30, 2012.

(51) Int. Cl. A61H 1/02

(52) U.S. Cl. CPC A61H 1/0288; A61H 1/0285; A61H 2201/0157; A61H 2201/1207; A61H 2201/501; A61H 2201/1664; A61H 2201/5041; A61H 2201/5061; A61H 2201/5064

(57) ABSTRACT

The Navigator is multiple degree of freedom neuro rehabilitation system. The Navigator simultaneously exercises both pronation and supination of the wrist (rotation) and flexion and extension of the fingers (grasp and release) for rehabilitation and monitoring of patients with motor control deficits due to a neurological ailment, such as stroke. In addition, the Navigator provides a visual, interactive environment for performing therapeutic exercises. The interactive environment provides motivation to the patient and can provide real-time feedback to the patient about the quality of the movements being performed.

### CROSS-REFERENCE TO RELATED APPLICATIONS

This application claims the benefit of U.S. Provisional Patent Application No. 61/732,008, filed on Nov. 30, 2012, which is incorporated herein by reference.

### BACKGROUND

1. Field of Invention

This invention generally relates to systems for hand and wrist rehabilitation. More particularly, the invention relates to a portable hand rehabilitation device that simultaneously exercises both pronation and supination of the wrist (rotation) and flexion and extension of the fingers (grasp and release).

2. Description of Related Art

Approximately 795,000 people in the United States annually suffer from stroke, and it is the leading cause of long-term disability in the nation. Of these stroke patients, 85% have arm impairment, and 55-75% retain that arm impairment after 3-6 months. In 2008, the direct and indirect cost of strokes totaled $8.8 billion. Stroke victims can suffer from serious motor system impairment, speech difficulties, and emotional problems, even long after their stroke.

Traditionally, occupational therapists use simple devices when working with hand patients. Blocks, weight, or hammers can be used to exercise finger flexion and extension, and wrist pronation and supination. These are the simplest devices available. Other devices use elastic energy to resist patients. These devices most commonly target finger or thumb extension and flexion. Though they can be manufactured out of plastic or rubber, elastic devices can also be as simple as pegboards used with rubber bands. These devices are inexpensive and the resistance can be changed easily by adding or removing rubber bands. Spring based devices, such as the Cando Pro exerciser, are also used. Spring devices are sturdier and can handle larger forces, but the resistance is usually fixed.

During the past decade, the field of neuro-rehabilitation has witnessed an increasing interest for the clinical use of robotic systems; particularly in the treatment of neurological ailments such as stroke and traumatic brain injury. Robotic training has several advantages, e.g., adaptability, data collection, motivation, alleviation of patient safety concerns, and the ability to provide intensive individualized repetitive practice. Studies on the use of robotic devices for upper extremity rehabilitation after stroke have shown significant increases in upper limb function, dexterity and fine motor manipulations, as well as improved proximal motor control.

However, there are no available robotic systems that simultaneously exercise both pronation and supination of the wrist (rotation) and flexion and extension of the fingers (grasp and release). These movements are required for many fine motor tasks that a person needs to be able to perform throughout the day, such as eating, handling objects, typing and writing. Thus a robotic device that facilitates the performance of coordinated wrist pronation/supination movements and trains hand grasp/release movements would be highly desirable because recovery of these movements is a problem in the rehabilitation of individuals post stroke.

### BRIEF SUMMARY

Systems for providing portable hand rehabilitation systems that that simultaneously exercise both pronation and supination of the wrist (rotation) and flexion and extension of the fingers (grasp and release) are provided. The system includes a linear actuation system to exercise the linear flexion and extension of the fingers while a rotational actuation system simultaneously exercises the rotational pronation and supination of the wrist. A controller calculates and commands the actuation systems to provide the desired linear and rotational force.

In another embodiment the linear actuation system is a rack and pinion powered by a DC motor. Alternatively, the linear actuation system may be linear voice coil or a Peaucellier linkage. The rotational actuation system may be a belt and pulley powered by a second DC motor. Alternatively, the rotational actuation system may include a spur gear transmission or a beveled gear transmission.

In another embodiment a visual, interactive environment for performing therapeutic exercises is provided. The interactive environment provides motivation to the patient and can provide real-time feedback to the patient about the quality of the movements being performed.

### BRIEF DESCRIPTION OF THE SEVERAL VIEWS OF THE DRAWINGS

For a more complete understanding of various embodiments of the present invention, reference is now made to the following descriptions taken in connection with the accompanying drawings in which:

FIG. 1 is a schematic illustration of one embodiment of the Navigator hand rehabilitation system;

FIG. 2 is a CAD model of one embodiment of the Navigator hand rehabilitation system;

FIG. 3A is a side view of one embodiment of a haptic handle;

FIG. 3B is a side view of a two-point pinch configuration of a haptic handle;

FIG. 3C is a side view of a three-point pinch configuration of a haptic handle;

FIG. 4A is a schematic illustration of one embodiment of a linear actuation system;

FIG. 4B is a bottom view of a linear actuation system;

FIG. 4C is a bottom view of a linear actuation system including a load cell;

FIG. 5A is a schematic illustration of one embodiment of a rotational actuation system;

FIG. 5B is a schematic illustration of a rotational actuation system including a torque sensor and encoder;

FIG. 6 is an illustration of an exemplary game for use with the Navigator hand rehabilitation system;

FIG. 7 is a schematic illustration of one embodiment of a rotational actuation system including a spur gear transmission;

FIG. 8 is a schematic illustration of one embodiment of a linear actuation system including a linear voice coil;

FIG. 9A is a schematic illustration of one embodiment of a rotational actuation system including a beveled gear;

FIG. 9B is a schematic illustration of one embodiment of a rotational actuation system including a torsional spring; and

FIG. 10 is a schematic illustration of one embodiment of a linear actuation system including a Peaucellier linkage.

### DETAILED DESCRIPTION

The hand rehabilitation system disclosed herein includes hardware and software components, which are described in greater detail below. The performance of the entire hand rehabilitation system depends on the proper selection and matching of components, which include simple mechanical elements such as gears and bearings as well as more advanced devices such as servo drives. The hardware components of the hand rehabilitation system include a multiple, e.g., two, degree-of-freedom (DOF) robotic hand rehabilitation interface; a gaming interface; and a computer-based controller with a data acquisition system.

### Navigator Hand Rehabiliation System

The Navigator Hand Rehabilitation System (“Navigator”) is a low cost hand rehabilitation device for home use that exercises finger flexion and extension (grasp and release) as well as wrist pronation and supination (rotation). The Navigator is self contained, low cost, lightweight (<7 kg) and is portable so that it can be adapted for use in clinical settings or in the home. The Navigator can be connected to a computer so that users can play a game to facilitate rehabilitation and to provide users and clinicians with objective rehabilitation data. A rack and pinion powered by a DC motor drives the linear flexion and extension of the fingers while a belt and pulley powered by a second DC motor drives the rotational pronation and supination of the wrist. An encoder, potentiometer, and torque and force sensors are used to track user inputs and device outputs. The control system can optionally include an microcontroller that manages device inputs and outputs so that users can play a virtual reality game as part of therapy.

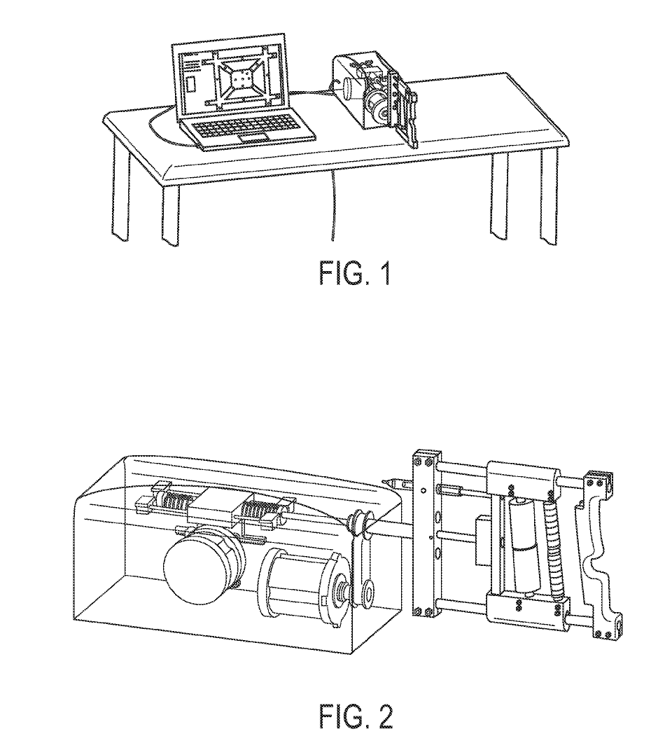

One embodiment of a Navigator hand rehabilitation system is illustrated in FIG. 1 and FIG. 2. The Navigator includes four major sub-assemblies: 1) a haptic handle, 2) a linear drive assembly, 3) a rotational drive assembly, and 4) control electronics. The Navigator fits on a medium sized desk along with a computer and keyboard and is completely enclosed in a case, except the haptic handle that is accessible for user interface. The case houses all of the motors and electronics and a CAD model of the system with the case is shown in FIG. 2.

### Haptic Handle

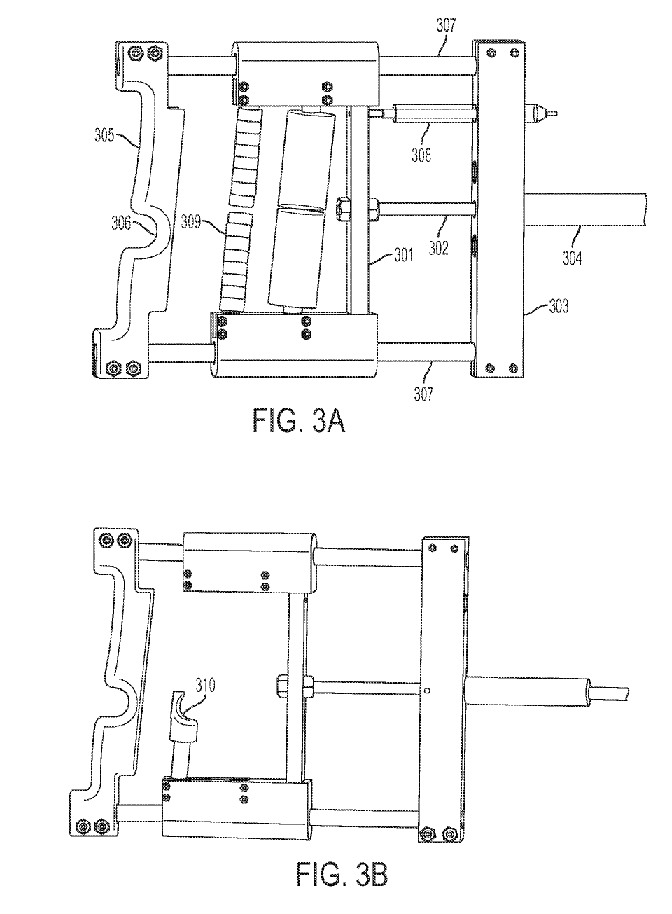

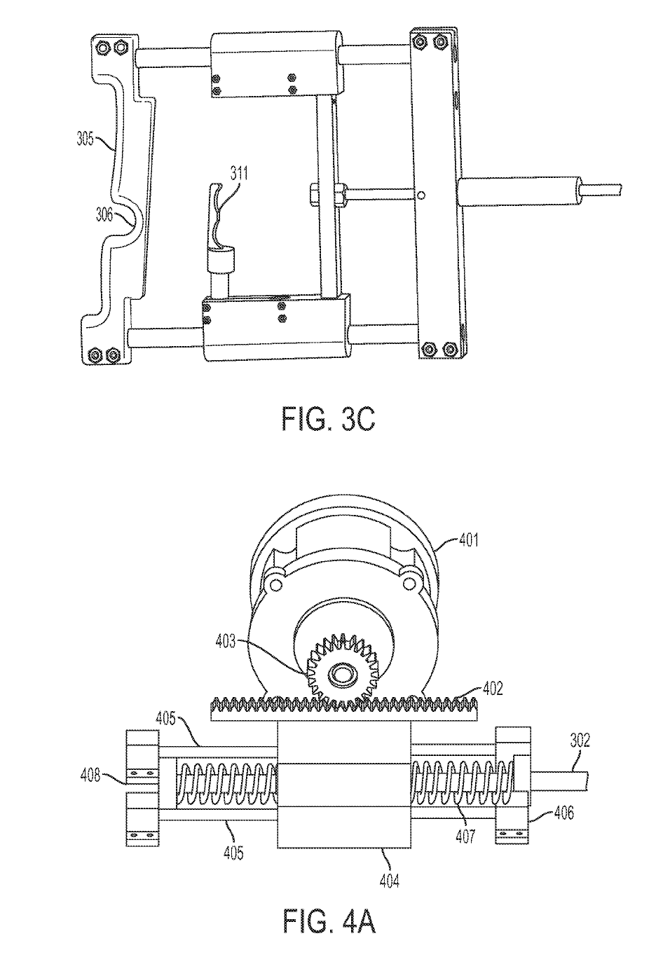

The haptic handle is shown in FIG. 3A [63]. Linear force is transmitted to the translating support 301 from the linear actuator through the inner shaft 302. Rotational force is transmitted to the rotating support 303 from the rotational actuator through the outer shaft 304. The inner shaft 302 may be 0.25″ in diameter and the outer shaft 304 may be 0.625″ in diameter. Palm support 305, including thumb support 306, is attached to the rotating support 303 via two guide rails 307. The translating support 301 moves between the rotating support 303 and the palm support 305 along the guide rails.

A linear potentiometer 308, can also be attached to the translating support 301, to measure absolute position of the translating support 301 with respect to the rotating support 303 or another fixed position such as the palm support 305. Linear potentiometers 308 are well known to the art and will not be discussed in detail. Preferably, the linear potentiometer 308 is adapted to provide displacement data directly to the controlling electronics. Similarly, the inner shaft 302 can connected to a load cell, not shown, which can in turn be connected to the translating support 301. The load cell can then provide pressure and/or strain data directly to the controlling electronics.

Translating support 301 can be configured with flexion and extension bars 308 to allow flexion/extension of the fingers, with rolling contact on both the distal and proximal sides of the fingers. This allows the patient to feel comfortable flexing and extending the fingers with minimal wrist flexion needed to conduct the desired exercise. Having a point of contact on each side of the finger also allows for force feedback while moving in either direction.

FIG. 3B shows a two-point pinch configuration of the haptic handle. In this configuration the flexion and extension bars 309 are replaced with a two-point pinch attachment 310. In the two-point pinch configuration, patients can exercise a pinch in which the thumb and index finger meet. This pinch is crucial movement for everyday life, and is therefore a high priority when rehabilitating the hand from injury or stroke.

FIG. 3C shows a three-point pinch configuration of the haptic handle. In this configuration the flexion and extension bars 309 are replaced with a three-point pinch attachment 311. The three-point pinch configuration allows the patient to complete a three-point pinch, in which the thumb meets the middle and index fingers. In this case the patient's thumb is placed in the thumb support 306 located in the palm support 305. The index and middle finger tips are placed in the three-point pinch attachment, allowing the patient to exercise this pinch motion. In all three configurations discussed above, the attachments are threaded, and therefore easily removable. The modular handle design will allow the patient to exercise many of the key motions of the hand as needed for any particular training objective.

### Linear Actuation System

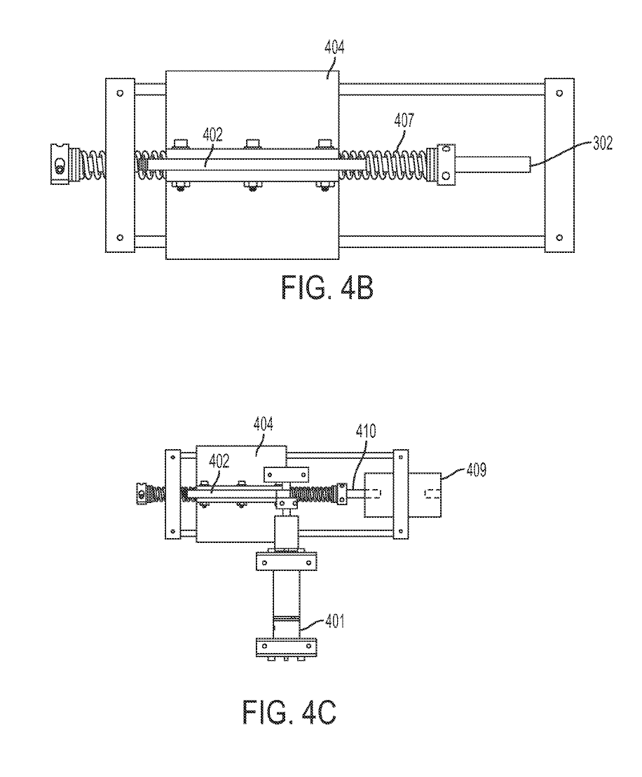

The linear actuation system is shown in FIG. 4A. The linear actuation system is powered by a DC motor 401 driving a rack 402 and pinion 403. The rack 402 and pinion 403 convert the rotary motion of DC motor 401 into linear motion. The rack 402 is connected to an alignment block 404 that slides along the alignment rods 405. Two alignment rods 405 prevent the alignment bock from rotating around the inner shaft 302. This limits the motion of the alignment block 404 to linear motion during operation of the rack 402 and pinion 403. In addition hard stops 406 prevent the alignment block 404 from moving beyond its design length along the alignment rods 405.

The alignment block 404 driven by a two elastic actuation systems, e.g. springs 407, in series. One end of each spring 407 is connected to the alignment block 404. The other end of each spring is connected to a shaft collar 408 that drives the inner shaft 302. Each spring will initially deflect under an impulse. Springs 407 are paired such that when the alignment block 404 is deflected, a force is applied to the alignment block 404 that will cause the alignment block 404 to return to its equilibrium position. The springs 407 are preloaded to the maximum expected load in order to ensure that the springs will never lose contact with the alignment block 404 and shaft collars 408.

FIG. 4B is a bottom view of the linear actuation system. This figure shows that applying a translation load to the haptic handle will cause the inner shaft 302 to move, further compressing spring 407, which in turn will move the alignment block 404 and rack 402. Similarly, applying a load to the DC motor will cause the rack 402 to move, again further compressing spring 407, which in turn will move the inner shaft 302 and the haptic handle.

FIG. 4C is a bottom view of one embodiment of the linear actuation system additionally showing a load cell 409. In this embodiment the rack 402 and pinion are connected to a center drive shaft 410. The load cell 409 is disposed between the center drive shaft 410 and the inner shaft that is connected to the haptic handle. The load cell 409 measures the linear force being applied by the DC motor 401 or by the patient via the haptic handle. Load cells 409 are well known to the art and will not be discussed in detail. In addition, a linear potentiometer, not shown in FIG. 4C, is used to measure the linear displacement of the alignment block 404. These measurements are used by the control logic as inputs to the feedback loop that controls the system.

### Rotational Actuation System

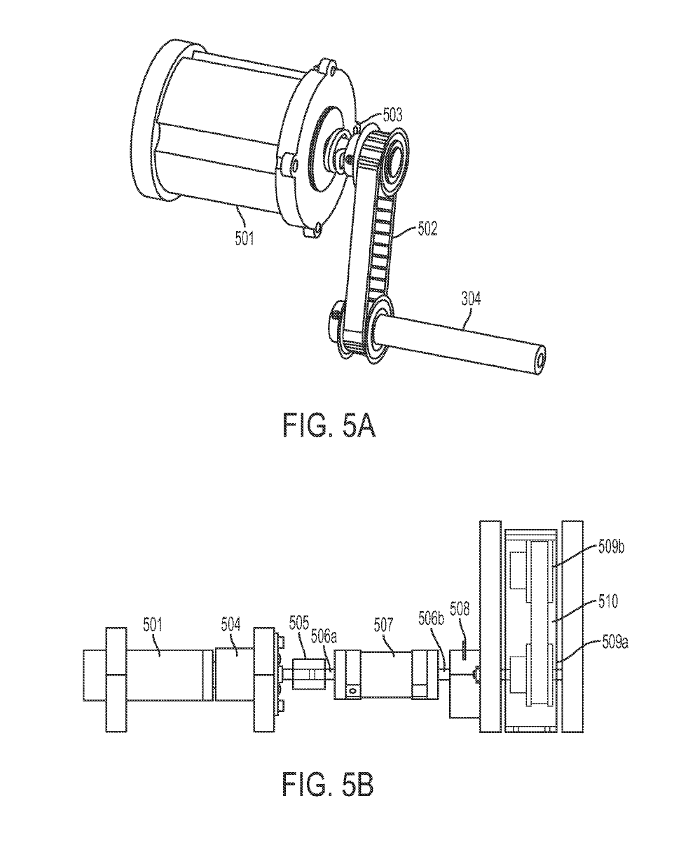

The rotational actuation system is shown in FIG. 5A. The rotational drive system is powered by a DC motor 501, with power transmitted to the outer shaft 304 using a pulley system or timing belt 502. The rotational actuation system can optionally incorporate an elastic option that can be used if smoothed actuation or shock absorption is required. In this case a torsional spring 503 can be mounted to the motor shaft. The other end of the spring can be attached to the pulley system 502 that drives the outer shaft 304.

FIG. 5B is a second view of the rotational actuation system additionally showing a torque sensor and encoder. As shown by the diagram, the rotation actuation system is driven by DC motor 501 and gear box 504. The shaft of the gear box 504 is coupled to an extended shaft 506 using a spider couple 505. The spider couple 505 includes an elastic element, which allows for torsional series elastic actuation without designing or requiring a spring. The extended shaft 506a coming out of the spider couple 505 ends with a mounting flange that allows for the mounting of a torque sensor 507. The opposite end of the torque sensor 507 is mounted to a second extended shaft 506b with a mounting flange. This shaft passes through a through-hole encoder 508, and connects to a first pulley wheel 509a. The first pulley wheel 509a is connected by a timing belt 510 to second pulley 509b on the shaft of the outer shaft 304. The use of a timing belt 510 as opposed to a V-belt will minimize the slip in the system. Both pulley wheels 509a and 509b are preferably mounted with set screws to their respective shafts. The pulley wheels 509a and 509b preferably have the same pitch diameter, allowing the torque to be transferred at a ratio of nearly 1:1. This increases the back drivability of the system.

### Electronic Control System

The Navigator system has all electronics enclosed in the package. The customer will only have two cables: a standard USB cable and a standard power cable. Because these are common cables, it will be easy for the consumer to install. The typical patient will be over the age of 65, so it is important for the setup of the electronics to be simple.

The electronic control system includes the motor controllers and power supplies for each DOF (rotation and translation), as well as amplifiers for the torque, displacement, and force sensors. The closed loop control for the system is preferably designed using an Arduino micro controller.

In addition the Navigator can interface with a virtual reality game on a PC. The connection of a gaming interface or engine to a rehabilitation system and its advantages are disclosed and described in greater detail in International Patent Application Number PCT/US2010/021483 filed on Jan. 20, 2010, which claims the benefit of U.S. Provisional Patent Application No. 61/145,825 filed on Jan. 20, 2009 and U.S. Provisional Patent Application No. 61/266,543, filed Dec. 4, 2009-all three of which are incorporated in their entirety herein by reference. As a result, the gaming interface function will not be described in great detail.

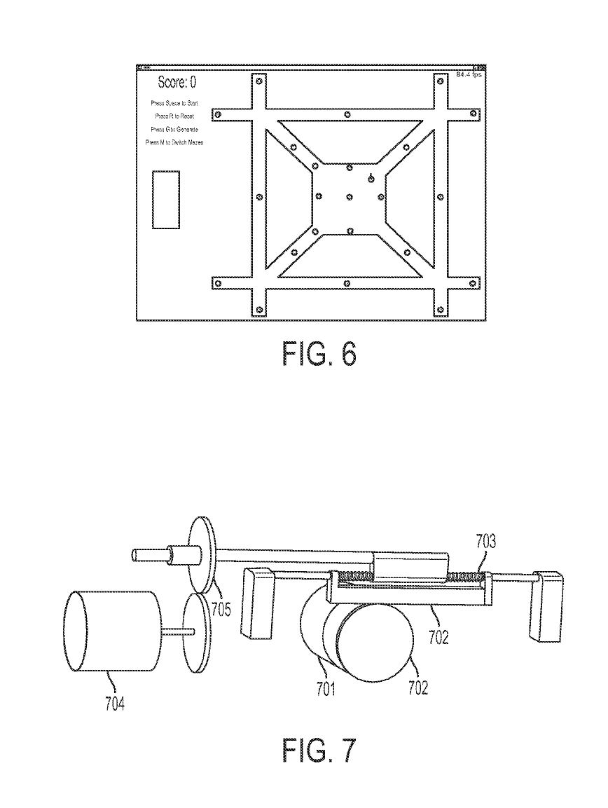

FIG. 6 shows an illustration of an exemplary game that can be run on a connected PC using input data from the Navigator system. The illustrative display is a two-dimensional maze, to which a first DOF of the Navigator system is coupled to a first dimension in the game and a second DOF of the Navigator system is coupled to a second dimension in the game. The game provides a visual, interactive environment for performing therapeutic exercises using the Navigator system. The game provides motivation to the patient and can provide real-time feedback to the patient about the quality of the movements being performed. In addition, the therapist can monitor the patient's performance and progress to evaluate his or her current state and to design future exercise goals.

### Additional Embodiments

In an alternative embodiment the rotational actuation system of the Navigator system described above can be implemented with a spur gear transmission. FIG. 7 shows a linear actuation system including a series elastic linear motor 701 driving a rack and pinion 702 and associated springs 703. The rotational actuation system includes a second motor 704 connected to a spur gear transmission 705, preferably with a 1:1 gear ratio.

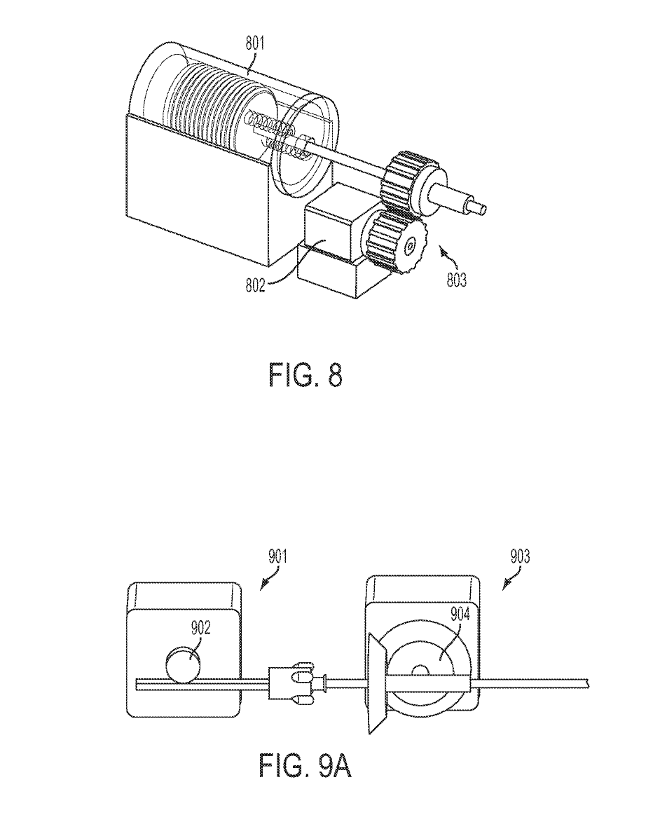

In an alternative embodiment the linear actuation system of the Navigator system described above can be implemented with a linear voice coil. FIG. 8 shows a linear actuation system including a linear voice coil 801 driving the linear motion of the system. The rotational actuation system includes a stepper motor 802 connected to a spur gear transmission 803, preferably with a 1:1 gear ratio.

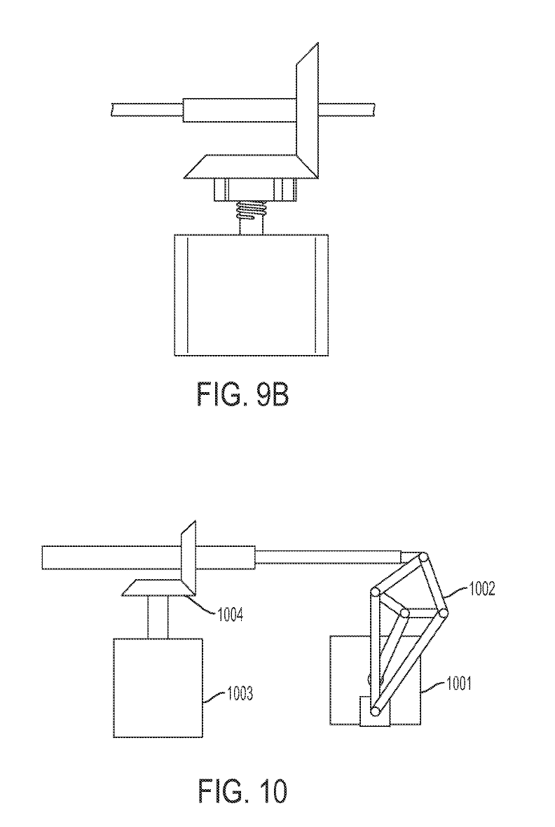

In an alternative embodiment the rotational actuation system of the Navigator system described above can be implemented with a beveled gear transmission. FIG. 9A shows a linear actuation system including a series elastic linear motor 901 driving a rack and pinion 902. The rotational actuation system includes a second motor 903 connected to a beveled gear transmission 904, preferably with a 1:1 gear ratio. As shown in FIG. 9B, the beveled gear transmission can optionally include a torsional spring connected between the stepper motor shaft and the beveled gear.

In an alternative embodiment the linear actuation system of the Navigator system described above can be implemented with a Peaucellier linkage. FIG. 10 shows a linear actuation system including a stepper motor 1001 and Peaucellier linkage 1002 driving the linear motion of the system. The rotational actuation system includes a motor 1003 connected to a bevel gear transmission 1004, preferably with a 1:1 gear ratio.

What is claimed is:

1. A hand rehabilitation device for a patient comprising:
a two degree-of-freedom robotic interface that provides force for each degree-of-freedom, further comprising:
a linear actuation system to provide at least one of a resistive force and a motive force to exercise flexion and extension of the patient's fingers;
a rotational actuation system to provide at least one of a resistive force and a motive force to exercise pronation and supination of the patient's wrist;
a haptic handle;
a controller for calculating a desired value for at least one of the resistive forces and the motive forces and commanding at least one of the linear actuation system and rotational actuation system to provide the desired force.

2. The device of claim 1 further comprising at least one sensor for measuring at least one of force, load, torque, angular displacement, angular velocity, displacement, and position.

3. The device of claim 2 wherein the controller is adapted to calculate a desired force value based in part on the output from the at least one sensor.

4. The system of claim 1, wherein the linear actuation system comprises a rack and pinion.

5. The system of claim 1, wherein the linear actuation system comprises a linear voice coil.

6. The system of claim 1, wherein the linear actuation system comprises a Peaucellier linkage.

7. The system of claim 1, wherein the rotational actuation system comprises a pulley system.

8. The system of claim 1, wherein the rotational actuation system comprises a spur gear transmission.

9. The system of claim 1, wherein the rotational actuation system comprises a beveled gear transmission.

10. The system of claim 1, further comprising a gaming interface that is structured and arranged with a display device to present a game to said patient.

11. A method for hand rehabilitation for a patient comprising:
calculating a desired value for at least one of a resistive force and a motive force to exercise flexion and extension of the patient's fingers;
calculating a desired value for at least one of a resistive force and a motive force to exercise pronation and supination of the patient's wrist;
commanding a linear actuation system to provide the desired at least one of a resistive force and a motive force to exercise flexion and extension of the patient's fingers; and
commanding a rotational actuation system to provide the desired at least one of a resistive force and a motive force to exercise pronation and supination of the patient's wrist.

12. The method of claim 11 further comprising measuring at least one of force, load, torque, angular displacement, angular velocity, displacement, and position of the patient's wrist or fingers.

13. The method of claim 12 wherein the desired force value is calculated based at least in part on the measurement of at least one of force, load, torque, angular displacement, angular velocity, displacement, and position of the patient's wrist or fingers.

14. The method of claim 11, wherein the linear actuation system comprises a rack and pinion.

15. The method of claim 11, wherein the linear actuation system comprises a linear voice coil.

16. The method of claim 11, wherein the linear actuation system comprises a Peaucellier linkage.

17. The method of claim 11, wherein the rotational actuation system comprises a pulley system.

18. The method of claim 11, wherein the rotational actuation system comprises a spur gear transmission.

19. The method of claim 11, wherein the rotational actuation system comprises a beveled gear transmission.

20. The method of claim 1, further comprising presenting a game to said patient.
